(19) United States
(12) Patent Application Publication
(10) Pub. No.: US 2026/0014704 A1
(43) Pub. Date: Jan. 15, 2026

(54) PROTECTION OF CABLE CONNECTORS

(71) Applicant: INTERNATIONAL BUSINESS MACHINES CORPORATION, ARMONK, NY (US)

(72) Inventors: Daniel Ruiz, Cold Spring, NY (US); Joseph Scaglione, Poughkeepsie, NY (US); RYAN ELSASSER, Salt Point, NY (US); Schuyler Mann, Poughkeepsie, NY (US)

(21) Appl. No.: 18/772,657

(22) Filed: Jul. 15, 2024

(51) Int. Cl. B25J 9/16; E05B 47/00; E05B 51/02; E05B 65/00; H01R 43/00

(52) U.S. Cl. CPC B25J 9/1687; E05B 47/0002; E05B 51/02; E05B 65/00; H01R 43/002

(57) ABSTRACT

A method, apparatus, and computer program product for protecting at least two cable connectors. A robot inserts a key housing of a fixture plate into a fixture plate holder hole in a fixture plate holder. The robot locks the fixture plate into the fixture plate holder via use of the key housing, a key pin, and a key spring which is mechanically coupled to the key pin. A key spring force imposed by the key spring on the key pin moves the key pin into a locked position within the key housing and the fixture plate holder. The locked position mechanically locks the fixture plate into the fixture plate holder. The key pin and the key spring are part of either the fixture plate or the fixture plate holder. The at least two cable connectors is attached to a top surface of the fixture plate.

### BACKGROUND

The present invention relates to protection of cable connectors, and more specifically, to prevention of human interaction with cable connectors attached to a fixture plate.

### SUMMARY

Embodiments of the present invention provide a method, an apparatus, and a computer program product, for protecting a plurality of cable connectors. A robot inserts a key housing of a fixture plate into a fixture plate holder hole in a fixture plate holder. The robot locks the fixture plate into the fixture plate holder via use of the key housing, a key pin, and a key spring which is mechanically coupled to the key pin. A key spring force imposed by the key spring on the key pin moves the key pin into a locked position within the key housing and the fixture plate holder. The locked position mechanically locks the fixture plate into the fixture plate holder. The key pin and the key spring are part of either the fixture plate or the fixture plate holder. The plurality of cable connectors is attached to a top surface of the fixture plate.

### BRIEF DESCRIPTION OF THE DRAWINGS

FIG. 1 depicts an exploded view of an apparatus for protecting a plurality of cable connectors attached to a fixture plate using a robot in conjunction with a fixture plate holder, in accordance with embodiments of the present invention.

FIG. 2 depicts an exploded view of the apparatus in FIG. 1 showing the fixture plate in more detail, in accordance with embodiments of the present invention.

FIG. 3 depicts a perspective view of the the fixture plate of FIG. 2, in accordance with embodiments of the present invention.

FIG. 4 depicts a top view of the the fixture plate of FIG. 2, in accordance with embodiments of the present invention.

FIG. 5 depicts an air compressor, in accordance with embodiments of the present invention.

FIG. 6 depicts the robot performing operations on the fixture plate using a vacuum pump within the robot, in accordance with embodiments of the present invention.

FIG. 7 depicts the robot performing operations on the fixture plate using an air compressor within the robot, in accordance with embodiments of the present invention.

FIG. 8 depicts the robot performing operations on the fixture plate using an electromagnet within the key housing and an electromagnet in a protection plate, in accordance with embodiments of the present invention.

FIG. 9 depicts a rotatable connector plate coupled to a bottom surface of the fixture plate at a hole in the fixture plate, in accordance with embodiments of the present invention.

FIG. 10 is a flow chart describing a method for protecting a plurality of cable connectors, in accordance with embodiments of the present invention.

FIG. 11 is a flow chart of alternative embodiments of the present invention for implementing a step in FIG. 10 for detaching the fixture plate from the fixture plate holder.

FIG. 12 is a flow chart of alternative embodiments of the present invention for implementing a step in claim 10 for exposing the plurality of cable connectors by a protection plate.

FIG. 13 is a flow chart of a process for implementing a step in claim 10 for exposing the plurality of cable connectors by a rotatable connector plate, in accordance with embodiments of the present invention.

FIG. 14 is a flow chart of alternative embodiments of the present invention for implementing a step in FIG. 10 for cleaning for cleaning the cable connectors above a cleaning channel.

FIG. 15 illustrates a computer system, in accordance with embodiments of the present invention.

FIG. 16 depicts a computing environment which contains an example of an environment for the execution of at least some of the computer code involved in performing the inventive methods, in accordance with embodiments of the present invention.

### DETAILED DESCRIPTION

Cables are delicate and expensive, and it is highly desirable for cables to be undamaged between arrival from the supplier to installation. Cable defects often occur between operations when operators manually plug and unplug the cables. The cables are typically unrestricted and are prone to contact damage or damage due to excessive manual plug force. Thus, cables should be handled carefully as any slight cable damage in manufacturing would require the cable to be replaced, which leads to significant idle time and process bottlenecks.

Embodiments of the present invention address the preceding problem by using a fixture plate that is locked into a fixture plate holder in a manner that prevents humans from tampering with cable connectors between arrival from a supplier to installation of the cables. In addition, the fixture plate being locked into the fixture plate holder facilitates visual inspection and cleaning of the cable connectors.

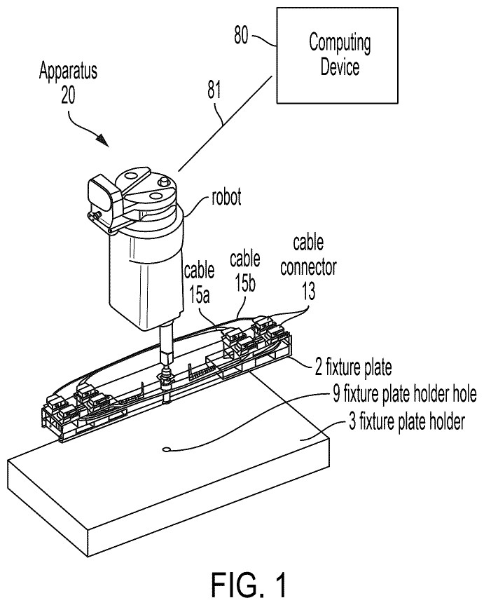

FIG. 1 depicts an exploded view of an apparatus 20 for protecting a plurality of cable connectors 13 attached to a fixture plate 2 using a robot 1 in conjunction with a fixture plate holder 3, in accordance with embodiments of the present invention. The embodiment of FIG. 1 depicts eight cable connectors 13.

The apparatus 20 includes the fixture plate 2, a fixture plate holder 3, and the robot 1.

In one embodiment, the fixture plate holder 3 is an assembly station or an inspection station at which the cable connectors may be inspected.

In one embodiment, the robot 1 is a robotic arm.

In one embodiment, the robot 1 may be powered by a normal 120 volt or 240 volt outlet or by a battery.

In one embodiment, the robot 1 is controlled by a computing device 80 and is communicatively coupled to the computing device 80 by a wired or wireless connection 81.

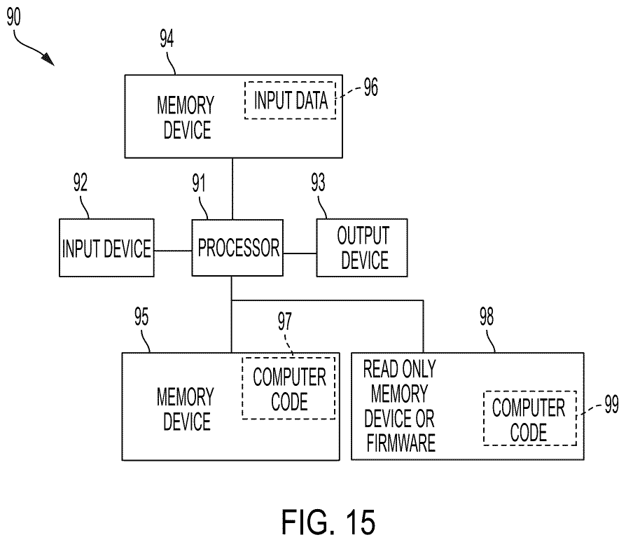

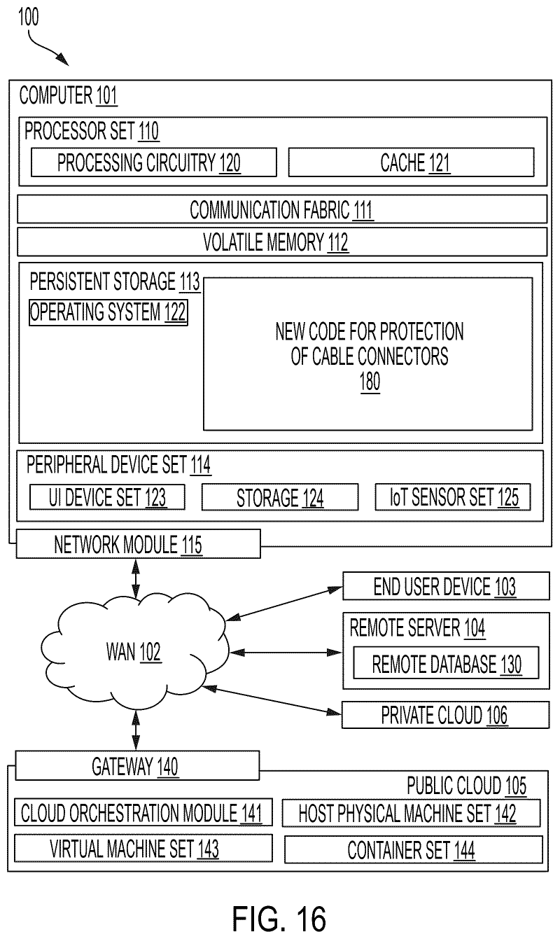

The computing device 80 may be: a stand-alone computer, a computer within a computer system such as, inter alia, the computer system of 90 of FIG. 15 or the computer environment 100 of FIG. 16; a hand-held computer (e.g., a palmtop computers, a personal digital assistant (PDA), a smartphone, a tablet, etc.); a special-purpose computer designed specifically to implement embodiment of the present invention (e.g., a computing device containing an application specific integrated circuit (ASIC)), etc.

Although the computing device 80 is depicted in FIG. 1 as being external to the robot 1, the computing device 80 may alternatively be disposed within the robot 1.

In one embodiment, the robot 1 is a collaborative robot (cobot), which is a robot that can safely work in proximity to humans. A cobot may be equipped with sensors that enable the cobot to navigate, and a safety mode may be activated if the cobot's movements are interrupted.

The fixture plate 2 includes a plurality of cable connectors 13, and cables 15a and 15b.

The cables 15a and 15b are packaged (e.g., by a manufacturer) by being plugged into cable connectors 13 in the fixture plate 2 where the cables 15a and 15b are in a consistent position and orientation in the fixture plate so that only robot 1, and not a human, can lift (i.e., pick up) the cables 15a and 15b and install the cables 15a an 15b where the cables 15a and 15b are to be plugged into a system to be used. For example, the robot 1 may pick up one end of the cable 15a and plug the one end into a module, and then the robot 1 may pick up the other end of the cable 15a and plug the other end into a power supply.

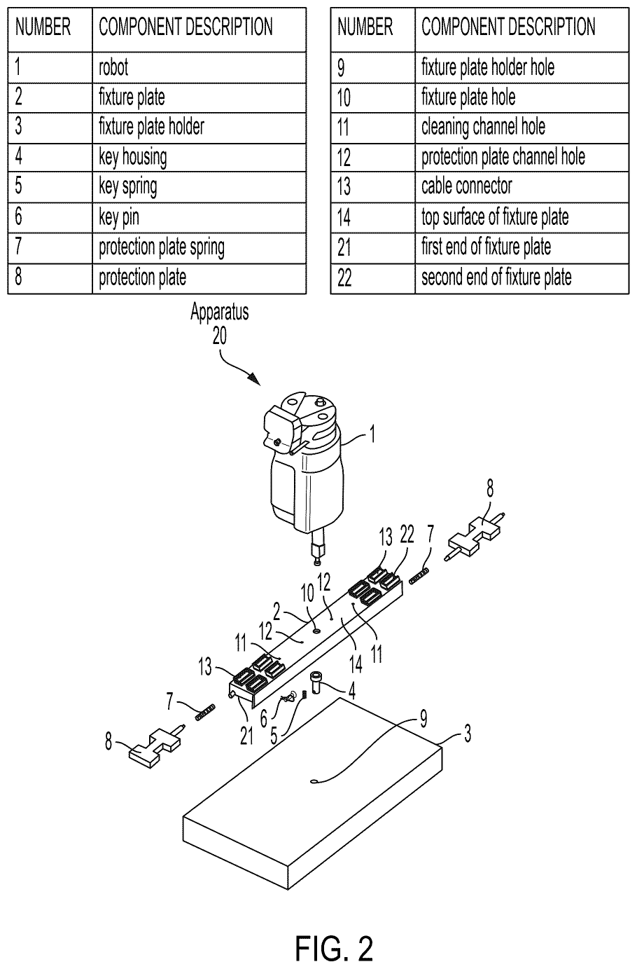

FIG. 2 depicts an exploded view of the apparatus 20 in FIG. 1 showing the fixture plate 2 in more detail, in accordance with embodiments of the present invention.

The plurality of cable connectors 13 is attached to a top surface 14 of the fixture plate 2.

The fixture plate 2 includes, in addition to the plurality of cable connectors 13, a protection plate 8 and a protection plate spring located at a first end 21 and at a second end 22 of the fixture plate 2. The protection plates 8 protect the cable connectors 13 from debris.

There are holes in the fixture plate 2 originating at a top surface 14 of the fixture plate 2, namely a fixture plate hole 10, two cleaning channel holes 11, and two protection plate channel holes 12.

The robot 1 is configured to fit on or into the fixture plate hole 10 to perform a detachment, from the fixture plate holder 3, of the fixture plate 2 that is locked into the fixture plate holder 3.

The two cleaning channel holes 11 are used by the robot 1 for cleaning the cable connectors 13.

The protection plate channel holes 12 are used by the robot 1 for moving the channel plate 8 in a manner that exposes the cable connectors 13.

The fixture plate 2 includes a key housing 4 configured to be inserted into a fixture plate holder hole 9 in the fixture plate holder 3 for locking the fixture plate 2 into the fixture plate holder 3 using a key pin 6 and a key spring 5.

The key housing 4 is part of the fixture plate 2.

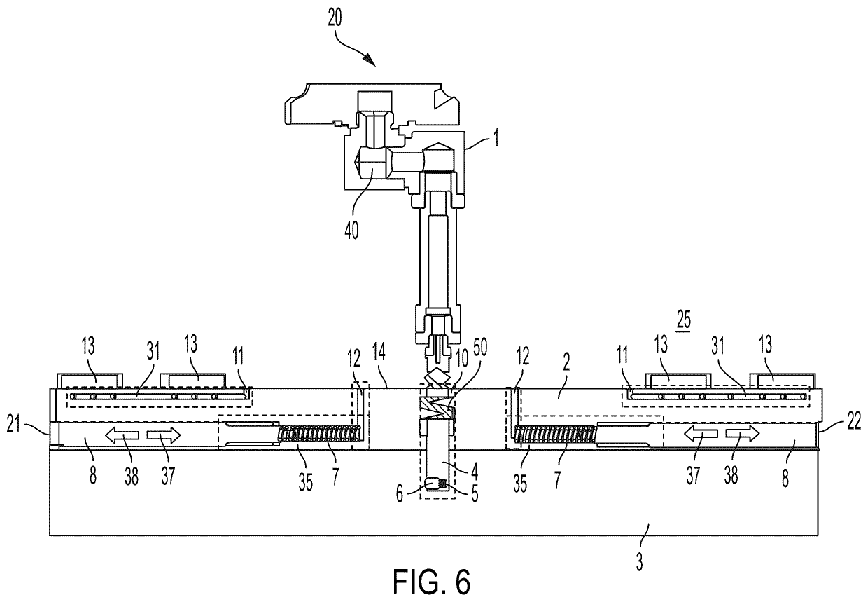

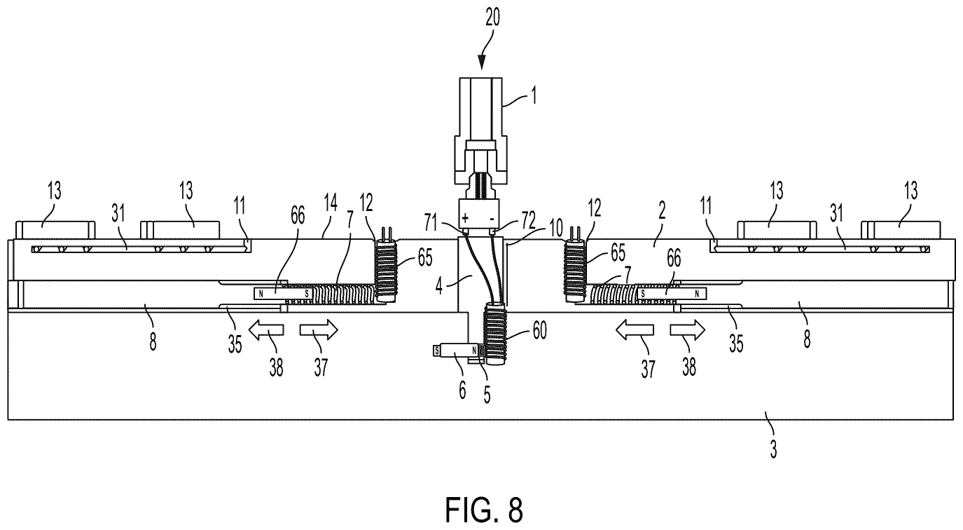

In vacuum embodiments and in electromagnet embodiments to be discussed infra in conjunction with FIG. 6 and FIG. 8, respectively, the key pin 6 and the key spring 5 are part of the fixture plate 2.

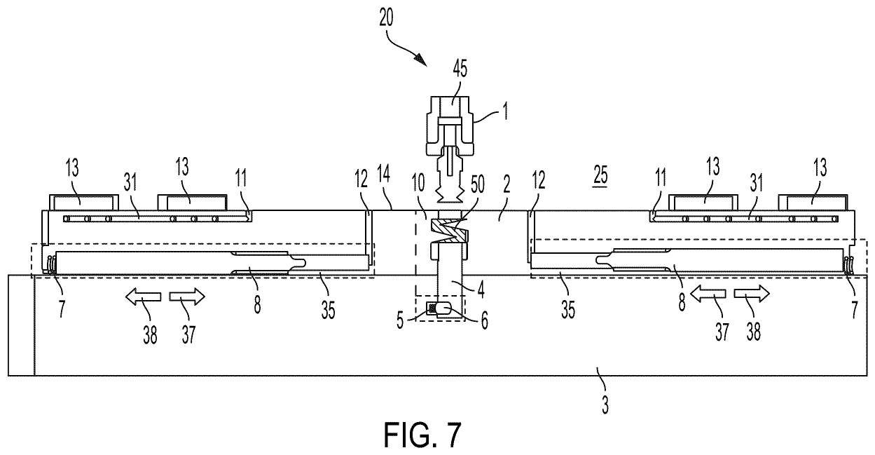

In air compressor embodiments to be discussed infra in conjunction with FIG. 7, the key pin 6 and the key spring 5 are part of the fixture plate holder 3.

The robot 1 is configured to insert the key housing 4 of the fixture plate 2 into the fixture plate holder hole 9 in the fixture plate holder 3.

The fixture plate holder 3 is configured to hold the fixture plate 2 in a locked position by locking, by the robot 1, the fixture plate 2 into the fixture plate holder 3 via use of the key housing 4, the key pin 6, and the key spring 5 mechanically coupled to the key pin 6. A key spring force imposed by the key spring 5 on the key pin 6 moves the key pin 6 into a locked position within the key housing 4 and the fixture plate holder 3. The locked position mechanically locks the fixture plate 2 into the fixture plate holder 3. The key pin 6 and the key spring 5 are part of either the fixture plate 2 or the fixture plate holder 3. The plurality of cable connectors 13 is attached to a top surface 14 of the fixture plate 2.

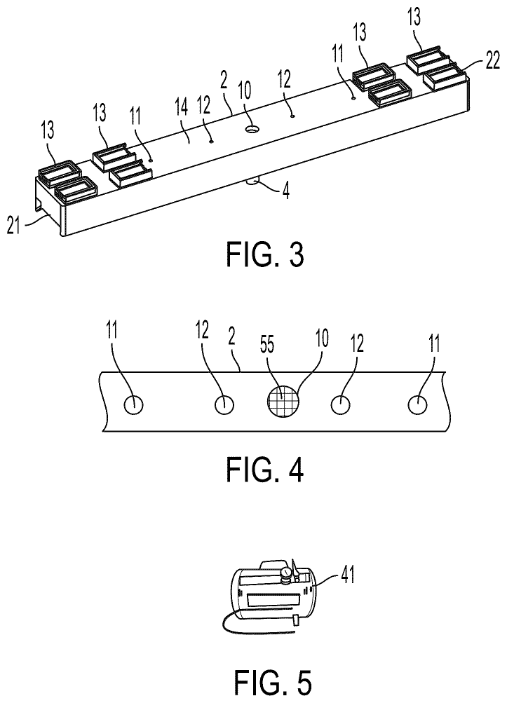

FIG. 3 depicts a perspective view of the the fixture plate 2 of FIG. 2, in accordance with embodiments of the present invention.

The plurality of cable connectors 13 is attached to the top surface 14 of the fixture plate 2.

The key housing 4 protrudes through a bottom of the fixture plate hole 10 for insertion into the fixture plate holder hole 9 of the fixture plate holder 3.

FIG. 4 depicts a top view of the the fixture plate 2 of FIG. 2, in accordance with embodiments of the present invention. A filter 55 is within or above the fixture plate hole 10 to trap debris (e.g., dust) that may otherwise enter the fixture plate hole 10. The filter 55 or its equivalent may be similarly placed within or above the cleaning channel hole 11 and/or the protection plate channel hole 12. In one embodiment, the filter 55 may be used to collect debris removed from a cleaning channel 31 (see FIG. 6 or FIG. 7) via the cleaning channel hole 11 as discussed infra.

FIG. 5 depicts an air compressor 41, in accordance with embodiments of the present invention. The air compressor 41 symbolizes an air compressor internal to, and used by, the robot 1 for implementing air compressor embodiments of the present invention as discussed infra in conjunction with FIG. 7.

Embodiments of the present invention include vacuum pump embodiments (FIG. 6), air compressor embodiments (FIG. 7), and electromagnet embodiments (FIG. 8).

FIG. 6 depicts the robot 1 performing operations on the fixture plate 2 using a vacuum pump 40 within the robot 1, in accordance with embodiments of the present invention.

The embodiments associated with FIG. 6 are vacuum embodiments in which the key pin 6 and the key spring 5 are part of the fixture plate 2 and are coupled to the key housing 4.

The plurality of cable connectors 13 is attached to the top surface 14 of the fixture plate 2.

The key housing 4 is partially disposed within the fixture plate hole 10.

The robot 1 inserts the key housing 4 of the fixture plate 2 into the fixture plate holder hole 9 (see FIG. 2) in the fixture plate holder 3.

The robot 1 can turn on or turn off the vacuum pump 40.

The robot 1 can move to the various holes of: fixture plate hole 10 (for actuating the key pin 6 to unlock the fixture plate 2 from the fixture plate holder 3), the cleaning channel holes 11 (for cleaning the cable connectors 13), and the protection plate channel holes 12 (for moving the protection plate 8 to expose the cable connectors 13). Turning on the vacuum pump 40 removes air from the various holes at which the robot 1 is positioned.

In an absence of a vacuum being created in the fixture plate hole 10, the fixture plate 2 is locked into the fixture plate holder 3 by a portion of the key pin 4 protruding out of the key housing 4 to engage physical structure in the fixture plate holder 3.

The fixture plate 2 may be unlocked from the fixture plate holder 3 by having the robot 1 turn on the vacuum pump 40.

The key pin 6 is configured to move inward in a direction 37 toward the key housing 4 or to move outward in a direction 38 away from the key housing 4, as determined by the magnitude of the spring force imposed on the key pin 6 by the key spring 5.

The fixture plate 2 is not locked into the fixture plate holder 3 if the key pin 6 is entirely within the key housing 4.

The fixture plate 2 is locked into the fixture plate holder 3 if the key pin 6 extends out of the key housing 4 in the direction 38 which causes the key pin 6 to engage structure in the fixture plate holder 3 so as to lock the fixture plate 2 into the fixture plate holder 3.

If there is no vacuum in the fixture plate hole 10, then the spring force of the key spring 5 pushes the key pin 6 outward away from the housing 4 in direction 38 to lock the fixture plate 2 into the fixture plate holder 3.

If the robot 1 is positioned at the fixture plate hole 10 and turns on the vacuum pump 40 to create a vacuum in the housing 4 by pulling air out of the fixture plate hole 10, then the key pin 6 overcomes the spring force of the key spring 5 and moves inward in direction 37 to become totally disposed within the key housing 4 to unlock the fixture plate 2 from the fixture plate holder 3. Once the vacuum pump 40 is turned off, the key spring 5 pushes a portion of the key pin 6 out of the housing 4 in direction 38 to lock the fixture plate 2 into the fixture plate holder 3.

Thus, the robot 1 generates a vacuum in the key housing 4 causing the key pin 6 to overcome the key spring force of the key spring 5 on the key pin 6, which results in the entire key pin 6 moving into the key housing 4 and out of the locked position, wherein the key pin 6 and the key spring 5 are part of the fixture plate 2.

The cable connectors 13 may be cleaned by having the robot 1 positioned at the cleaning channel hole 11 which is coupled to a cleaning channel 31. The robot 1 turns on the vacuum pump 40 to create a vacuum in the cleaning channel hole 11 and the cleaning channel 31, which removes debris from the cleaning channel 31 in a vicinity of the cable connectors 13, so that the debris is subsequently evacuated into the cleaning channel hole 11 and then into the filter 55 (see FIG. 4) or into an ambient environment 25 above the fixture plate 2. The filter 55 depicted in FIG. 4 may be placed within or above the cleaning channel hole 11 to collect the removed debris.

The cable connectors 13 may be exposed by having the robot 1 positioned at the protection plate channel hole 12 which is coupled to a protection plate cleaning channel 35. Exposing the cable connectors 13 facilitates inspection or repair of the cable connectors 13.

If there is no vacuum in the protection plate channel hole 12, then the protection plate 8 is positioned in the protection plate cleaning channel 35 below the cable connector cables 13 to protect the cable connector cables 13 as depicted in FIG. 6.

If the robot 1 turns on the vacuum pump 40 to create a vacuum in the protection plate channel hole 12 and the protection plate channel 35 by pulling air out of the protection plate channel hole 12, then the protection plate 8 overcomes the spring force of the protection plate spring 7 and moves inward in direction 37 to expose the cable connectors 13.

A non-linear geometry 50 of the key housing 4 serves as an obstacle configured to prevent a human from inserting an object (e.g., a screwdriver or paper clip) through the key housing 4 that would move the key pin 6 to unlock the fixture plate 2 from the fixture plate holder 3.

FIG. 7 depicts the robot 1 performing operations on the fixture plate 2 using an air compressor 45 within the robot 1, in accordance with embodiments of the present invention. The embodiments associated with FIG. 7 are air compressor embodiments in which the key pin 6 and the key spring 5 are part of the fixture plate holder 3. The key housing 4 is partially disposed within the fixture plate hole 10.

The air compressor 45 does not have the physical appearance of the air compressor 41 in FIG. 4 and is physically structured to be compatible with the interior structure and functionality of the robot 1. The robot 1 can turn on or turn off the air compressor 45.

The apparatus 20 in FIG. 7 differs from the apparatus 20 in FIG. 6 in that that the air compressor 45 has replaced the vacuum pump 40, and the position of the key spring 5 and the protection spring 7 differ in FIGS. 6 and 7. The relative positions of the key spring 5 and the key pin 6 are reversed with respect to the key housing 4 in FIGS. 6 and 7. The relative positions of the protection plate spring 7 and the protection plate 8 are reversed with respect to the key housing 4 in FIGS. 6 and 7.

The robot 1 can move to the various holes of: fixture plate hole 10 (for actuating the key pin 6 to unlock the fixture plate 2 from the fixture plate holder 3), the cleaning channel holes 11 (for cleaning the cable connectors 13), and the protection plate channel holes 12 (for moving the protection plate 8 to expose the cable connectors 13). Turning on the air compressor 45 injects compressed air into whichever hole of the various holes that the robot 1 is at.

In an absence of compressed air being injected into the fixture plate hole 10, the fixture plate 2 is locked into the fixture plate holder 3.

The fixture plate 2 may be unlocked from the fixture plate holder 3 by having the robot 1 turn on the air compressor 45.

The key pin 6 is configured to move inward in a direction 37 toward the key housing 4 or to move outward in a direction 38 from the key housing 4, as determined by the magnitude of the spring force imposed on the key pin 6 by the key spring 5.

The fixture plate 2 is not locked into the fixture plate holder 3 if the key pin 6 is entirely outside of the key housing 4.

The fixture plate 2 is locked into the fixture plate holder 3 if a portion of the key pin 6 extends into the key housing 4 in the direction 37 which causes the key pin 6 to engage the key housing 4 so as to lock the fixture plate 2 into the fixture plate holder 3.

If there is no compressed air injected into the fixture plate hole 10, then the key spring 5 extends into the key housing 4 in the direction 37 which causes the key pin 6 to engage the key housing 4 so as to lock the fixture plate 2 into the fixture plate holder 3.

If the robot 1 is positioned at the fixture plate hole 10 and turns on the air compressor 45 to inject compressed air into the key housing 4, then the compressed air applies a force on the key pin 6 causing the key pin 6 to overcome the key spring force of the key spring 5 on the key pin 6, which results in the entire key pin 6 moving out of the key housing 4 outward in direction 38 and into the fixture plate holder 3 to release the key housing 4 which unlocks the fixture plate 2 from the fixture plate holder 3.

The cable connectors 13 may be cleaned by having the robot 1 disposed at the cleaning channel hole 11 which is coupled to a cleaning channel 31. The robot 1 turns on the air compressor 45 to inject compressed air into the cleaning channel hole 11 and the cleaning channel 31, which removes debris from the cleaning channel 31 in a vicinity of the cable connectors 13, so that the debris is subsequently evacuated from the cleaning channel hole 11 and then into the filter 55 (see FIG. 4) or into an ambient environment 25 above the fixture plate 2. The filter 55 depicted in FIG. 4 may be placed within or above the cleaning channel hole 11 to collect the removed debris.

The cable connectors 13 may be exposed by having the robot 1 positioned at the protection plate channel hole 12 which is coupled to a protection plate channel 35. Exposing the cable connectors 13 facilitates inspection or repair of the cable connectors 13.

If there is no compressed air injected into the protection plate channel hole 12, then the protection plate 8 is positioned in the protection plate cleaning channel 35 below the cable connector cables 13 to protect the cable connector cables 13 as depicted in FIG. 7.

If the robot 1 turns on the air compressor 45 to inject compressed air into the protection plate channel hole 12 and the protection plate channel 35, then the compressed air applies a force on the protection plate 8 causing the protection plate 8 to overcome the key spring force of the protection plate spring 7 on the protection plate 8 which results the entire protection plate 8 moving outward in direction 38 to expose the connector cables 13.

A non-linear geometry 50 of the key housing 4 serves as an obstacle configured to prevent a human from inserting an object (e.g., a screwdriver or paper clip) through the key housing 4 that would move the key pin 6 to unlock the fixture plate 2 from the fixture plate holder 3.

FIG. 8 depicts the robot 1 performing operations on the fixture plate 2 using an electromagnet 60 within the key housing 4 and an electromagnet 65 in the protection plate 8, in accordance with embodiments of the present invention. The embodiments associated with FIG. 8 are electromagnet embodiments in which the key pin 6 and the key spring 5 are part of the fixture plate 2 and are coupled to the key housing 4.

The robot 1 can generate an electromagnet 60 by touching the terminal (71 or 72) of the key housing 4, which sends an electric current through coils surrounding a core of magnetic material. The robot 1 can remove the electromagnet 60 by terminating the touching of the terminal (71 or 72) of the key housing 4. The magnetic material surrounded by the coils may include, inter alia, iron, steel, nickel, cobalt, etc.

The electromagnet 60 generates a magnetic field that attracts the key pin 6 due to a permanent magnetic material in the key pin 6. The permanent magnetic material in the key pin 6 may include, inter alia, hard ferrites (e.g., Nd—Fe—B, sintered Nd—Fe—B, sintered Sm—Co), alnico, samarium cobalt, neodymium, etc.

The robot 1 can generate the electromagnets 65 by touching the terminals of the fixture plates 8, which sends an electric current through coils surrounding a core of magnetic material. The robot 1 can remove the electromagnets 65 by terminating the touching of the terminal of the fixture plates 8. The magnetic material surrounded by the coils may include, inter alia, iron, steel, nickel, cobalt, etc.

The electromagnet 65 generates a magnetic field that attracts the fixture plates 8 due to a permanent magnetic material in the key pin 6. The permanent magnetic material in the fixture plates 8 may include, inter alia, hard ferrites (e.g., Nd—Fe—B, sintered Nd—Fe—B, sintered Sm—Co), alnico, samarium cobalt, neodymium, etc.

The robot 1 can move to the various holes of: fixture plate hole 10 (for actuating the key pin 6 to unlock the fixture plate 2 from the fixture plate holder 3) and the protection plate channel holes 12 (for moving the protection plate 8 to expose the cable connectors 13).

The location of the key spring 5 relative to the key pin 6 and the housing 4 in the electromagnet embodiments of FIG. 8 is similar to location of the key spring 5 relative to the key pin 6 and the housing 4 in the vacuum embodiments of FIG. 6.

In an absence of the electromagnet 60, the fixture plate 2 is locked into the fixture plate holder 3 by a portion of the key pin 4 protruding out of the key housing 4 to engage physical structure in the fixture plate holder 3, which also occurs in the vacuum embodiments of FIG. 6.

The fixture plate 2 may be unlocked from the fixture plate holder 3 by having the robot 1 generate the electromagnet 60.

The key pin 6 is configured to move inward in a direction 37 toward the key housing 4 or to move outward in a direction 38 away from the key housing 4, as determined by the magnitude of the spring force imposed on the key pin 6 by the key spring 5.

The fixture plate 2 is not locked into the fixture plate holder 3 if the key pin 6 is entirely within the key housing 4.

The fixture plate 2 is locked into the fixture plate holder 3 if the key pin 6 extends out of the key housing 4 in the direction 38 which causes the key pin 6 to engage structure in the fixture plate holder 3 so as to lock the fixture plate 2 into the fixture plate holder 3.

In an absence of the electromagnet 60, the spring force of the key spring 5 pushes a portion of the key pin 6 outward away from the housing 4 in direction 38 to lock the fixture plate 2 into the fixture plate holder 3.

If the robot 1 is positioned at the fixture plate hole 10 and generates the electromagnet 60 to create a magnetic field, then the magnetic field attracts the key pin 6 due to the permanent magnetic material in the key pin 6 which enables the key pin 6 to overcome the spring force of the key spring 5 causing the key pin 6 to move inward in direction 37 to become totally disposed within the key housing 4 to unlock the fixture plate 2 from the fixture plate holder 3. Once the electromagnet 60 is removed, the key spring 5 pushes a portion of the key pin 6 out of the housing 4 in direction 38 to lock the fixture plate 2 into the fixture plate holder 3.

Thus, the robot 1 generates the electromagnet 60 within the key housing 4 by sending an electric current through a coil surrounding a magnetic material disposed in the key housing. A magnetic field of the electromagnet 60 attracts the key pin 6 by attracting a permanent magnetic material in the key pin 6 causing the key pin 6 to overcome the key spring force of the key spring 5 on the key pin 6 which results in the entire key pin moving into the key housing 4 and out of the locked position. The key pin 6 and the key spring 5 are part of the fixture plate 2.

The cable connectors 13 may be exposed by having the robot 1 positioned at the protection plate channel hole 12 which is coupled to a protection plate cleaning channel 35. Exposing the cable connectors 13 facilitates inspection or repair of the cable connectors 13.

In an absence of the electromagnet 65, there is no magnetic field to attract the protection plate 8 and the protection plate 8 is thus positioned in the protection plate channel 35 below the cable connector cables 13 to protect the cable connector cables 13 as depicted in FIG. 8.

If the robot 1 generates the electromagnet 65, a magnetic field generated by the electromagnet 65 attracts the protection plate 8 due to the permanent magnetic material in the protection plate 8 which enables the protection plate 8 to overcome the spring force of the protection plate spring 7 causing the protection plate 8 to move inward in direction 37 to expose the cable connectors 13. Once the electromagnet 65 is removed, the protection plate spring 7 pushes the protection plate 8 outward in direction 38 to protect the cable connectors 13.

Thus, the robot 1 generates the electromagnet 65 within the protection plate by sending an electric current through a coil surrounding a magnetic material in the protection plate 8. A magnetic field generated by the electromagnet 65 attracts the protection plate 8 by attracting a permanent magnetic material in the protection plate 8 causing the protection plate 8 to overcome the protection plate spring force of the protection plate spring 7 on the protection plate 8, which results in the protection plate 8 moving to a location in the protection plate channel 35 that exposes the one or more cable connectors.

The non-linear geometry 50 of the key housing 4 depicted in FIGS. 6 and 7 also exists for the electromagnetic embodiments of FIG. 8 but is not explicitly shown in FIG. 8.

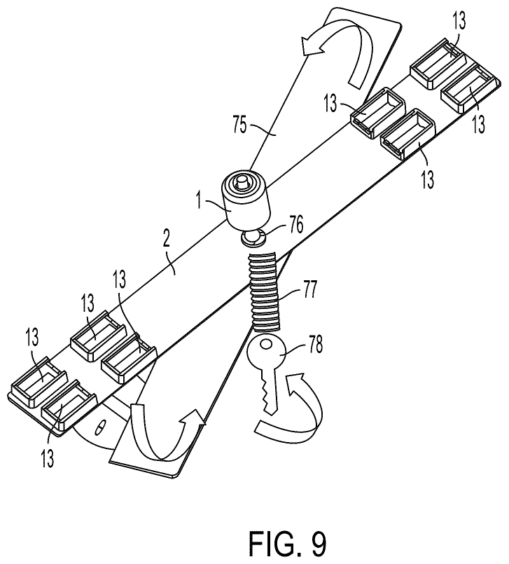

FIG. 9 depicts a rotatable connector plate 75 coupled to a bottom surface of the fixture plate 2 at a hole 76 in the fixture plate 2, in accordance with embodiments of the present invention. A torsional spring force exerted by a torsional spring 77 constrains the fixture plate 2 to be in rotational alignment with the rotatable connector plate 75 to protect the plurality of cable connectors 13.

The robot 1 may turn a key 78 attached to the torsional spring 77, which causes the torsional spring 77 to rotate the rotatable connector plate 75 relative to the fixture plate 2 to create an angular deviation 0 from the rotational alignment to expose the plurality of cable connectors 13. The angular deviation 0 must exceed a specified threshold angular deviation in order to fully expose the plurality of cable connectors 13.

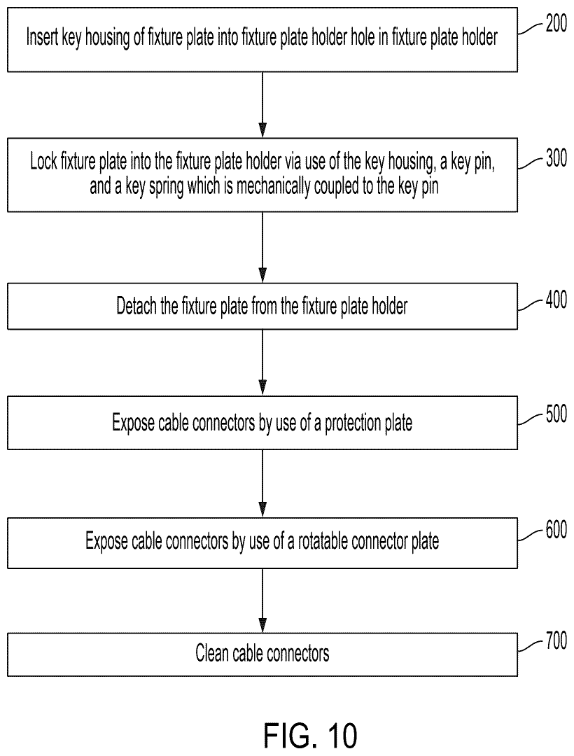

FIG. 10 is a flow chart describing a method for protecting a plurality of cable connectors 13, in accordance with embodiments of the present invention. The flow chart of FIG. 10 includes steps 200, 300, 400, 500, 600 and 700.

In step 200, a robot 1 inserts a key housing 4 of a fixture plate 2 into a fixture plate holder hole 9 in a fixture plate holder 3.

In step 300, the robot 1 locks the fixture plate 2 into the fixture plate holder 3 via use of the key housing 4, the key pin 6, and the key spring 5 which is mechanically coupled to the key pin 6. A key spring force imposed by the key spring 5 on the key pin 6 moves the key pin 6 into a locked position within the key housing 4 and the fixture plate holder 3. The locked position mechanically locks the fixture plate 2 into the fixture plate holder 3. The key pin 6 and the key spring 5 are part of either the fixture plate 2 or the fixture plate holder 3. The plurality of cable connectors 13 is attached to a top surface 14 of the fixture plate 2.

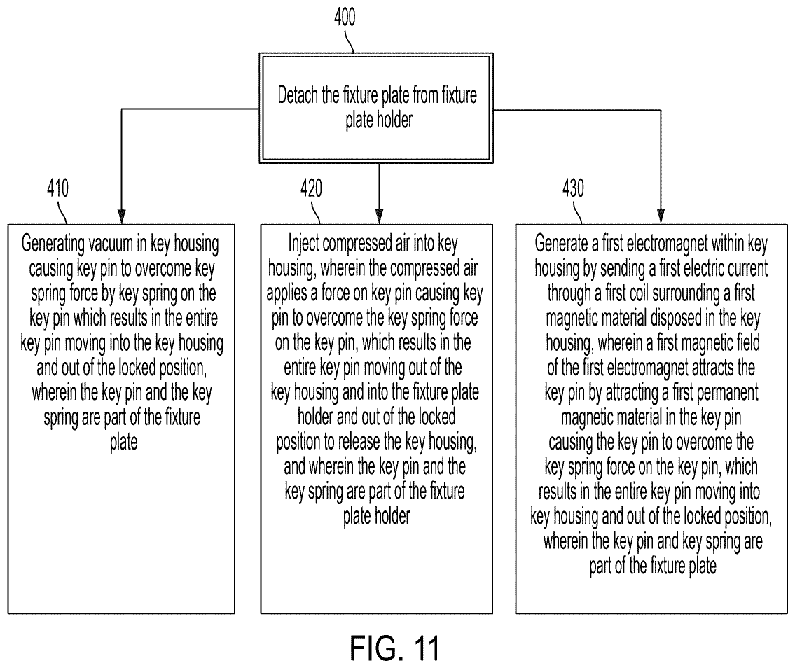

In step 400, the robot 1 detaches the fixture plate 2 from the fixture plate holder 3. Alternative embodiments for implementing step 400 are presented in FIG. 11 described infra.

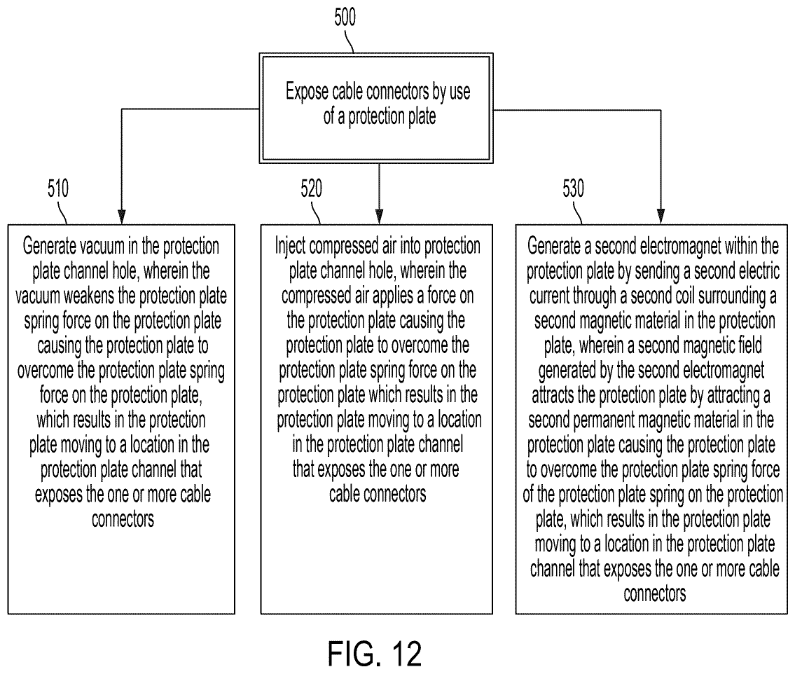

In step 500, the robot 1 exposes one or more cable connectors of the plurality of cable connectors 13 by use of a protection plate 8. Alternative embodiments for implementing step 500 are presented in FIG. 12 described infra.

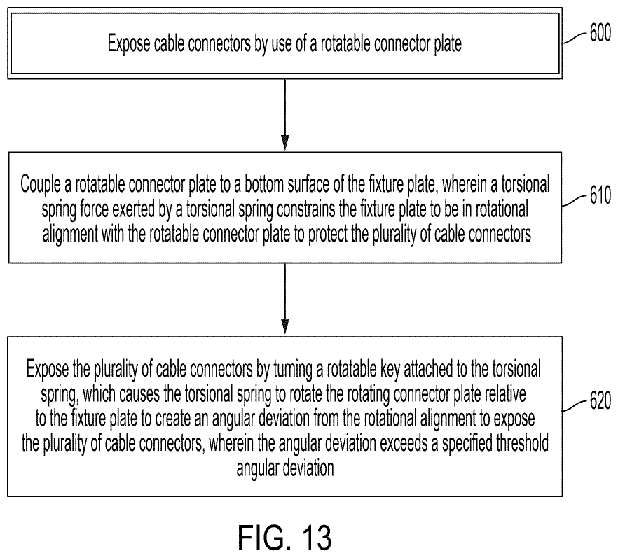

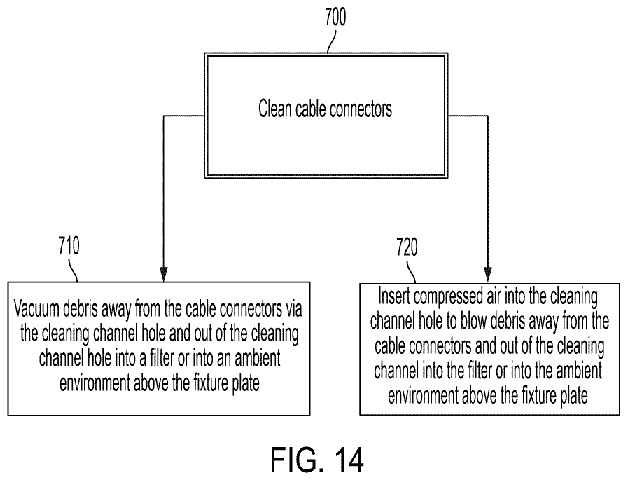

In step 600, the robot 1 exposes the plurality of cable connectors 13 by use of a rotatable connector plate 75. Step 600 is described in more detail in FIG. 13.

The fixture plate 8 comprises a cleaning channel hole 11 leading to a cleaning channel 31 beneath cable connectors of the plurality of cable connectors 13 and oriented approximately parallel to the top surface 14 of the fixture plate 2.

In step 700, the robot 1 cleans the cable connectors 13. Alternative embodiments for implementing step 700 are presented in FIG. 14 described infra.

FIG. 11 is a flow chart of alternative embodiments 410, 420, and 430 of the present invention for implementing step 400 of FIG. 10 for detaching the fixture plate from the fixture plate holder.

Embodiment 410 is a vacuum embodiment in which the robot 1 generates a vacuum in the key housing 4 causing the key pin 6 to overcome the key spring force by the key spring 5 on the key pin 6 which results in the entire key pin 6 moving into the key housing 4 and out of the locked position, wherein the key pin 6 and the key spring 5 are part of the fixture plate 2.

Embodiment 420 is a compressed air embodiment in which the robot 1 injects compressed air into the key housing 4, wherein the compressed air applies a force on the key pin 6 causing the key pin 6 to overcome the key spring force on the key pin 6, which results in the entire key pin 6 moving out of the key housing 4 and into the fixture plate holder 3 and out of the locked position to release the key housing 4, and wherein the key pin 6 and the key spring 5 re part of the fixture plate holder 3.

Embodiment 430 is an electromagnet embodiment in which the robot 1 generates a first electromagnet 60 within the key housing 4 by sending a first electric current through a first coil surrounding a first magnetic material disposed in the key housing 4, wherein a first magnetic field of the first electromagnet 60 attracts the key pin 6 by attracting a first permanent magnetic material in the key pin 6 causing the key pin 6 to overcome the key spring force on the key pin 6, which results in the entire key pin 6 moving into the key housing 4 and out of the locked position, and wherein the key pin 6 and the key spring 5 are part of the fixture plate 2.

FIG. 12 is a flow chart of alternative embodiments 510, 520, and 530 of the present invention for implementing step 500 of FIG. 10 for exposing the plurality of cable connectors by a protection plate 8.

For embodiments 510, 520, and 530, the fixture plate 2 comprises a protection plate channel hole 12 leading to a protection plate channel 35 beneath one or more cable connectors of the plurality of cable connectors 13 and oriented approximately parallel to the top surface 14 of the fixture plate 2, wherein a protection plate spring force applied to a protection plate 8 by a protection plate spring 7 constrains the protection plate 8 to positions in the protection plate channel 35 that protect the one or more cable connectors 13.

Embodiment 510 is a vacuum embodiment in which the robot 1 generates a vacuum in the protection plate channel hole 12, wherein the vacuum weakens the protection plate spring force on the protection plate 8 causing the protection plate 8 to overcome the protection plate spring force on the protection plate 8, which results in the protection plate moving to a location in the protection plate channel 35 that exposes the one or more cable connectors 13.

Embodiment 520 is a compressed air embodiment in which the robot 1 injects compressed air into the protection plate channel hole 12, wherein the compressed air applies a force on the protection plate 8 causing the protection plate 8 to overcome the protection plate spring force on the protection plate 8, which results in the protection plate 8 moving to a location in the protection plate channel 35 that exposes the one or more cable connectors 13.

Embodiment 530 is an electromagnet embodiment in which the robot 1 generates a second electromagnet 65 within the protection plate 8 by sending a second electric current through a second coil surrounding a second magnetic material in the protection plate 8, wherein a second magnetic field generated by the second electromagnet 65 attracts the protection plate 8 by attracting a second permanent magnetic material in the protection plate 8 causing the protection plate 8 to overcome the protection plate spring force of the protection plate spring 7 on the protection plate 8, which results in the protection plate 8 moving to a location in the protection plate channel 35 that exposes the one or more cable connectors 13.

FIG. 13 is a flow chart of a process for implementing step 600 of FIG. 10 for exposing the plurality of cable connectors 13 by a rotatable connector plate 75, in accordance with embodiments of the present invention. The process of FIG. 13 includes steps 610 and 620.

Step 610 couples a rotatable connector plate 75 to a bottom surface of the fixture plate 2, wherein a torsional spring force exerted by a torsional spring 77 constrains the fixture plate to be in rotational alignment with the rotatable connector plate to protect the plurality of cable connectors 13.

In step 620, the robot 1 exposes the plurality of cable connectors by turning a rotatable key 78 attached to the torsional spring 77, which causes the torsional spring 77 to rotate the rotatable connector plate 75 relative to the fixture plate 2 to create an angular deviation θ from the rotational alignment to expose the plurality of cable connectors 13, wherein the angular deviation θ exceeds a specified threshold angular deviation.

FIG. 14 is a flow chart of alternative embodiments 710 and 720 of the present invention for implementing step 700 of FIG. 10 for cleaning the cable connectors above the cleaning channel 31.

For embodiments 710 and 720, the fixture plate 2 comprises a cleaning channel hole 11 leading to a cleaning channel 31 beneath cable connectors of the plurality of cable connectors 13 and oriented approximately parallel to the top surface 14 of the fixture plate 2.

Embodiment 710 is a vacuum embodiment in which the robot 1 vacuums debris away from the protection plate 8 via the cleaning channel hole 11 and out of the cleaning channel hole 11 into a filter 55 or into an ambient environment 25 above the fixture plate 2.

Embodiment 720 is a compressed air embodiment in which the robot 1 inserts compressed air into the cleaning channel hole 11 to blow debris away from the protection plate 8 and out of the cleaning channel 11 into the filter 55 or into the ambient environment 25 above the fixture plate 2.

FIG. 15 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 15 shows the computer system 90 as a particular configuration of hardware and software, any configuration of hardware and software, as would be known to a person of ordinary skill in the art, may be utilized for the purposes stated supra in conjunction with the particular computer system 90 of FIG. 15. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 16 depicts a computing environment 100 which contains an example of an environment for the execution of at least some of the computer code involved in performing the inventive methods, in accordance with embodiments of the present invention. Such computer code includes new code for protection of cable connectors 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for protecting a plurality of cable connectors, said method comprising:
inserting, by a robot, a key housing of a fixture plate into a fixture plate holder hole in a fixture plate holder; and
locking, by the robot, the fixture plate into the fixture plate holder via use of the key housing, a key pin, and a key spring which is mechanically coupled to the key pin, wherein a key spring force imposed by the key spring on the key pin moves the key pin into a locked position within the key housing and the fixture plate holder, wherein the locked position mechanically locks the fixture plate into the fixture plate holder, wherein the key pin and the key spring are part of either the fixture plate or the fixture plate holder, and wherein the plurality of cable connectors is attached to a top surface of the fixture plate.

2. The method of claim 1, wherein the method comprises: detaching, by the robot, the fixture plate from the fixture plate holder by:
generating a vacuum in the key housing causing the key pin to overcome the key spring force by the key spring on the key pin which results in the entire key pin moving into the key housing and out of the locked position, wherein the key pin and the key spring are part of the fixture plate; or
injecting compressed air into the key housing, wherein the compressed air applies a force on the key pin causing the key pin to overcome the key spring force on the key pin, which results in the entire key pin moving out of the key housing and into the fixture plate holder and out of the locked position to release the key housing, and wherein the key pin and the key spring are part of the fixture plate holder; or
generating a first electromagnet within the key housing by sending a first electric current through a first coil surrounding a first magnetic material disposed in the key housing, wherein a first magnetic field of the first electromagnet attracts the key pin by attracting a first permanent magnetic material in the key pin causing the key pin to overcome the key spring force on the key pin, which results in the entire key pin moving into the key housing and out of the locked position, and wherein the key pin and the key spring are part of the fixture plate.

3. The method of claim 1, wherein the key housing comprises a non-linear geometry that serves as an obstacle configured to prevent a human from inserting an object through the key housing in a manner that would move the key pin to unlock the fixture plate from the fixture plate holder.

4. The method of claim 1, wherein the fixture plate comprises a protection plate channel hole leading to a protection plate channel beneath one or more cable connectors of the plurality of cable connectors and oriented approximately parallel to the top surface of the fixture plate, wherein a protection plate spring force applied to a protection plate by a protection plate spring constrains the protection plate to positions in the protection plate channel that protect the one or more cable connectors, and wherein the method comprises: exposing, by the robot, the one or more cable connectors by:
generating a vacuum in the protection plate channel hole, wherein the vacuum weakens the protection plate spring force on the protection plate causing the protection plate to overcome the protection plate spring force on the protection plate, which results in the protection plate moving to a location in the protection plate channel that exposes the one or more cable connectors; or
injecting compressed air into the protection plate channel hole, wherein the compressed air applies a force on the protection plate causing the protection plate to overcome the protection plate spring force on the protection plate, which results in the protection plate moving to a location in the protection plate channel that exposes the one or more cable connectors; or
generating a second electromagnet within the protection plate by sending a second electric current through a second coil surrounding a second magnetic material in the protection plate, wherein a second magnetic field generated by the second electromagnet attracts the protection plate by attracting a second permanent magnetic material in the protection plate causing the protection plate to overcome the protection plate spring force of the protection plate spring on the protection plate, which results in the protection plate moving to a location in the protection plate channel that exposes the one or more cable connectors.

5. The method of claim 1, wherein a rotatable connector plate is coupled to a bottom surface of the fixture plate, wherein a torsional spring force exerted by a torsional spring constrains the fixture plate to be in rotational alignment with the rotatable connector plate to protect the plurality of cable connectors, and wherein the method comprises: exposing, by the robot, the plurality of cable connectors by:
turning a rotatable key attached to the torsional spring, which causes the torsional spring to rotate the rotatable connector plate relative to the fixture plate to create an angular deviation from the rotational alignment to expose the plurality of cable connectors, wherein the angular deviation exceeds a specified threshold angular deviation.

6. The method of claim 1, wherein the fixture plate comprises a cleaning channel hole leading to a cleaning channel beneath cable connectors of the plurality of cable connectors and oriented approximately parallel to the top surface of the fixture plate, and wherein the method comprises:
cleaning, by the robot, the cable connectors by:
vacuuming debris away from the cable connectors via the cleaning channel hole and out of the cleaning channel hole into a filter or into an ambient environment above the fixture plate; or
inserting compressed air into the cleaning channel hole to blow debris away from the cable connectors and out of the cleaning channel into the filter or into the ambient environment above the fixture plate.

7. The method of claim 1, wherein the robot is controlled by a computer device external to the robot.

8. An apparatus for protecting a plurality of cable connectors, said apparatus comprising:
a fixture plate; and
a fixture plate holder,
wherein the fixture plate is locked into the fixture plate holder via a key housing of the fixture plate, a key pin, and a key spring which is mechanically coupled to the key pin, wherein a key spring force imposed by the key spring on the key pin moves the key pin into a locked position within the key housing and the fixture plate holder, wherein the locked position mechanically locks the fixture plate into the fixture plate holder, wherein the key pin and the key spring are part of either the fixture plate or the fixture plate holder, and wherein the plurality of cable connectors is attached to a top surface of the fixture plate.

9. The apparatus of claim 8, wherein the apparatus comprises for detaching the fixture plate from the fixture plate holder:
a vacuum in the key housing causing the key pin to overcome the key spring force by the key spring on the key pin which results in the entire key pin being configured to move into the key housing and out of the locked position, wherein the key pin and the key spring are part of the fixture plate; or
compressed air in the key housing, wherein the compressed air applies a force on the key pin causing the key pin to overcome the key spring force on the key pin which results in the entire key pin being configured to move out of the key housing and into the fixture plate holder and out of the locked position to release the key housing, and wherein the key pin and the key spring are part of the fixture plate holder; or
a first electromagnet within the key housing having been generated by a first electric current having been sent through a first coil surrounding a first magnetic material disposed in the key housing, wherein a first magnetic field of the first electromagnet attracts the key pin by attracting a first permanent magnetic material in the key pin causing the key pin to overcome the key spring force on the key pin which results in the entire key pin being configured to move into the key housing and out of the locked position, and wherein the key pin and the key spring are part of the fixture plate.

10. The apparatus of claim 8, wherein the key housing comprises a non-linear geometry that serves as an obstacle configured to prevent a human from inserting an object through the key housing in a manner that would move the key pin to unlock the fixture plate from the fixture plate holder.

11. The apparatus of claim 8, wherein the fixture plate comprises a protection plate channel hole leading to a protection plate channel beneath one or more cable connectors of the plurality of cable connectors and oriented approximately parallel to the top surface of the fixture plate, wherein a protection plate spring force applied to a protection plate by a protection plate spring constrains the protection plate to positions in the protection plate channel that protect the one or more cable connectors, and wherein the apparatus comprises for exposing the one or more cable connectors:
a vacuum in the protection plate channel hole, wherein the vacuum weakens the protection plate spring force on the protection plate causing the protection plate to overcome the protection plate spring force on the protection plate which results in the protection plate being configured to move to a location in the protection plate channel that exposes the one or more cable connectors; or
compressed air in the protection plate channel hole, wherein the compressed air applies a force on the protection plate causing the protection plate to overcome the protection plate spring force on the protection plate which results in the protection plate being configured to move to a location in the protection plate channel that exposes the one or more cable connectors; or
a second electromagnet within the fixture plate having been generated by a second electric current having been sent through a second coil surrounding a second magnetic material in the protection plate, wherein a second magnetic field of the second electromagnet attracts the protection plate by attracting a second permanent magnetic material in the protection plate causing the protection plate to overcome the protection plate spring force on the protection plate which results in the protection plate being configured to move to a location in the protection plate channel that exposes the one or more cable connectors.

12. The apparatus of claim 8, wherein a rotatable connector plate is coupled to a bottom surface of the fixture plate, wherein a torsional spring force exerted by a torsional spring constrains the fixture plate to be in rotational alignment with the rotatable connector plate to protect the plurality of cable connectors, and wherein the apparatus comprises for exposing the plurality of cable connectors:
the rotatable connector plate;
the torsional spring; and
a rotatable key attached to the torsional spring,
wherein the rotatable key is configured to be turned to cause the torsional spring to rotate the rotatable connector plate relative to the fixture plate to create an angular deviation from the rotational alignment to expose the plurality of cable connectors, and wherein the angular deviation exceeds a specified threshold angular deviation.

13. The apparatus of claim 8, wherein the fixture plate comprises a cleaning channel hole leading to a cleaning channel beneath cable connectors of the plurality of cable connectors and oriented approximately parallel to the top surface of the fixture plate, and wherein the apparatus comprises for cleaning the cable connectors:
a vacuum in the cleaning channel, said vacuum configured to draw debris away from the cable connectors and out of the cleaning channel into a filter or into an ambient environment above the fixture plate; or
compressed air in the cleaning channel, said compressed air configured to blow debris away from the cable connectors and out of the cleaning channel into the filter or into the ambient environment above the fixture plate.

14. The apparatus of claim 8, wherein the robot is controlled by a computer device disposed within the robot.

15. A computer program product, comprising one or more computer readable hardware storage devices having computer readable program code stored therein, said program code containing instructions executable by one or more processors of a computer system to implement a method for protecting a plurality of cable connectors, said method comprising:
inserting, by a robot, a key housing of a fixture plate into a fixture plate holder hole in a fixture plate holder; and
locking, by the robot, the fixture plate into the fixture plate holder via use of the key housing, a key pin, and a key spring which is mechanically coupled to the key pin, wherein a key spring force imposed by the key spring on the key pin moves the key pin into a locked position within the key housing and the fixture plate holder, wherein the locked position mechanically locks the fixture plate into the fixture plate holder, wherein the key pin and the key spring are part of either the fixture plate or the fixture plate holder, and wherein the plurality of cable connectors is attached to a top surface of the fixture plate.

16. The computer program product of claim 15, wherein the method comprises: detaching, by the robot, the fixture plate from the fixture plate holder by:
generating a vacuum in the key housing causing the key pin to overcome the key spring force by the key spring on the key pin which results in the entire key pin moving into the key housing and out of the locked position, wherein the key pin and the key spring are part of the fixture plate; or
injecting compressed air into the key housing, wherein the compressed air applies a force on the key pin causing the key pin to overcome the key spring force on the key pin, which results in the entire key pin moving out of the key housing and into the fixture plate holder and out of the locked position to release the key housing, and wherein the key pin and the key spring are part of the fixture plate holder; or
generating a first electromagnet within the key housing by sending a first electric current through a first coil surrounding a first magnetic material disposed in the key housing, wherein a first magnetic field of the first electromagnet attracts the key pin by attracting a first permanent magnetic material in the key pin causing the key pin to overcome the key spring force on the key pin, which results in the entire key pin moving into the key housing and out of the locked position, and wherein the key pin and the key spring are part of the fixture plate.

17. The computer program product of claim 15, wherein the key housing comprises a non-linear geometry that serves as an obstacle configured to prevent a human from inserting an object through the key housing in a manner that would move the key pin to unlock the fixture plate from the fixture plate holder.

18. The computer program product of claim 15, wherein the fixture plate comprises a protection plate channel hole leading to a protection plate channel beneath one or more cable connectors of the plurality of cable connectors and oriented approximately parallel to the top surface of the fixture plate, wherein a protection plate spring force applied to a protection plate by a protection plate spring constrains the protection plate to positions in the protection plate channel that protect the one or more cable connectors, and wherein the method comprises: exposing, by the robot, the one or more cable connectors by:
generating a vacuum in the protection plate channel hole, wherein the vacuum weakens the protection plate spring force on the protection plate causing the protection plate to overcome the protection plate spring force on the protection plate, which results in the protection plate moving to a location in the protection plate channel that exposes the one or more cable connectors; or
injecting compressed air into the protection plate channel hole, wherein the compressed air applies a force on the protection plate causing the protection plate to overcome the protection plate spring force on the protection plate, which results in the protection plate moving to a location in the protection plate channel that exposes the one or more cable connectors; or
generating a second electromagnet within the protection plate by sending a second electric current through a second coil surrounding a second magnetic material in the protection plate, wherein a second magnetic field generated by the second electromagnet attracts the protection plate by attracting a second permanent magnetic material in the protection plate causing the protection plate to overcome the protection plate spring force of the protection plate spring on the protection plate, which results in the protection plate moving to a location in the protection plate channel that exposes the one or more cable connectors.

19. The computer program product of claim 15, wherein a rotatable connector plate is coupled to a bottom surface of the fixture plate, wherein a torsional spring force exerted by a torsional spring constrains the fixture plate to be in rotational alignment with the rotatable connector plate to protect the plurality of cable connectors, and wherein the method comprises: exposing, by the robot, the plurality of cable connectors by:
turning a rotatable key attached to the torsional spring, which causes the torsional spring to rotate the rotatable connector plate relative to the fixture plate to create an angular deviation from the rotational alignment to expose the plurality of cable connectors, wherein the angular deviation exceeds a specified threshold angular deviation.

20. The computer program product of claim 15, wherein the fixture plate comprises a cleaning channel hole leading to a cleaning channel beneath cable connectors of the plurality of cable connectors and oriented approximately parallel to the top surface of the fixture plate, and wherein the method comprises: cleaning, by the robot, the cable connectors by:
vacuuming debris away from the cable connectors via the cleaning channel hole and out of the cleaning channel hole into a filter or into an ambient environment above the fixture plate; or
inserting compressed air into the cleaning channel hole to blow debris away from the cable connectors and out of the cleaning channel into the filter or into the ambient environment above the fixture plate.
